(19) United States
(12) Patent Application Publication
(10) Pub. No.: US 2021/0262416 A1
(43) Pub. Date: Aug. 26, 2021

(54) TURBOFAN ENGINE WITH CORE EXHAUST AND BYPASS FLOW MIXING

(71) Applicant: General Electric Company, Schenectady, NY (US)

(72) Inventors: Kishanjit Pal, Bangalore (IN); Bhaskar Nanda Mondal, Bangalore (IN); Lajith Vijayan, Bangalore (IN)

(21) Appl. No.: 16/796,256

(22) Filed: Feb. 20, 2020

(51) Int. Cl. F02K 3/062; F02K 3/075; F02C 9/18

(52) U.S. Cl. CPC F02K 3/062; F02C 3/04; F02C 9/18; F02K 3/075

(57) ABSTRACT

A gas turbine engine, the engine including a core turbine engine forming a core flowpath, a rotatable first stage blade assembly in which a bypass airflow passage is formed downstream of the first stage blade assembly, and a shroud positioned at the bypass airflow passage radially outward of the core turbine engine, wherein a first flowpath is formed outward of the shroud at which a first portion of air is flowed, and wherein the shroud and the core turbine engine form a second flowpath therebetween, the core flowpath in fluid communication with the second flowpath to flow a mixture of a second portion of air and combustion gases in the second flowpath.

### FIELD

The present subject matter relates generally to flow mixing structures for turbofan engines.

### BACKGROUND

Turbofan engine configurations may include mixer assemblies configured to mix an exhaust gas flow and fan bypass airflow. Low bypass turbofan engines may include mixer assemblies to reduce noise or improve fuel consumption. However, as fan bypass airflow increases, the effectiveness of mixing assemblies and/or propulsive efficiency decreases, and/or weight increases at the engine may unacceptably increase fuel burn or fuel consumption if propulsive efficiency is maintained or at all increased. As such, known mixer assemblies may be deficient in providing acoustic attenuation and/or improving propulsive efficiency while maintaining or decreasing fuel burn or fuel consumption for larger engines, such as high bypass turbofan engines.

As such, there is a need for structures that provide acoustic attenuation, fuel consumption and fuel burn improvement, and/or weight reduction benefits for turbofan engines. Furthermore, there is a need for such structures in high bypass turbofan engines.

### BRIEF DESCRIPTION

Aspects and advantages of the invention will be set forth in part in the following description, or may be obvious from the description, or may be learned through practice of the invention.

An aspect of the present disclosure is directed to a gas turbine engine including a core turbine engine forming a core flowpath, a rotatable first stage blade assembly in which a bypass airflow passage is formed downstream of the first stage blade assembly, and a shroud positioned at the bypass airflow passage radially outward of the core turbine engine. A first flowpath is formed outward of the shroud at which a first portion of air is flowed, and the shroud and the core turbine engine form a second flowpath therebetween. The core flowpath is in fluid communication with the second flowpath to flow a mixture of a second portion of air and combustion gases in the second flowpath.

Another aspect of the present disclosure is directed to a high bypass gas turbine engine. The high bypass gas turbine engine includes an outer casing surrounding a core turbine engine in which the core turbine engine forms a core flowpath, a fan assembly rotatable relative to a longitudinal centerline axis, the fan assembly forming a bypass airflow passage aft of the fan assembly radially outward of the outer casing, and a splitter positioned in the bypass airflow passage. A first flowpath is formed at the bypass airflow passage radially outward of the splitter. The first flowpath receives a first portion of bypass air from the fan assembly. A second flowpath is formed between the splitter and the outer casing. The second flowpath receives a second portion of bypass air from the fan assembly. The core flowpath is in fluid communication with the second flowpath to flow a mixture of the second portion of bypass air and combustion gases in the second flowpath.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a schematic cross-section view of an exemplary gas turbine engine according to various embodiments of the present subject matter; and

FIG. 2 provides a schematic cross-section view of an exemplary gas turbine engine according to various embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “forward” and “aft” refer to relative positions within a propulsion system or vehicle, and refer to the normal operational attitude of the propulsion system or vehicle. For example, with regard to a propulsion system, forward refers to a position closer to a propulsion system inlet and aft refers to a position closer to a propulsion system nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Embodiments of turbofan engines, such as high bypass turbofan engines, are provided that may improve acoustic attenuation and decrease specific fuel consumption and improve fuel burn over known turbofan engines or high bypass gas turbine engines. Embodiments of the engines provided herein include a bypass duct splitter shroud at a bypass airflow passage. In certain embodiments, the bypass shroud is positioned around an outer casing of the core turbine engine to provide a volume of a bypass airflow/combustion gases mixing passage at which propulsive efficiency is increased, noise and acoustics are attenuated, and/or weight is desirably maintained such as to further allow improved specific fuel consumption and/or fuel burn. In various embodiments provided herein, the engine includes certain ranges and/or ratios of fan bypass ratios, mass flow ratios, and/or pressure ratios corresponding to at least the bypass shroud such as to provide radial spacing and/or length or other structures that provide benefits not previously known to turbofan engines, such as high bypass turbofan engines.

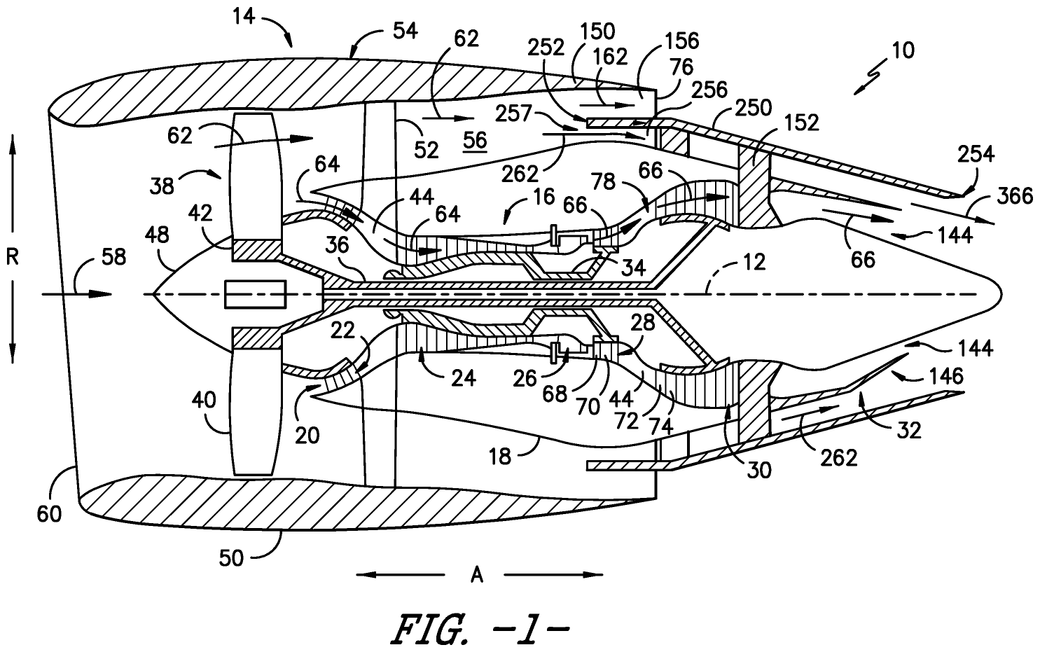

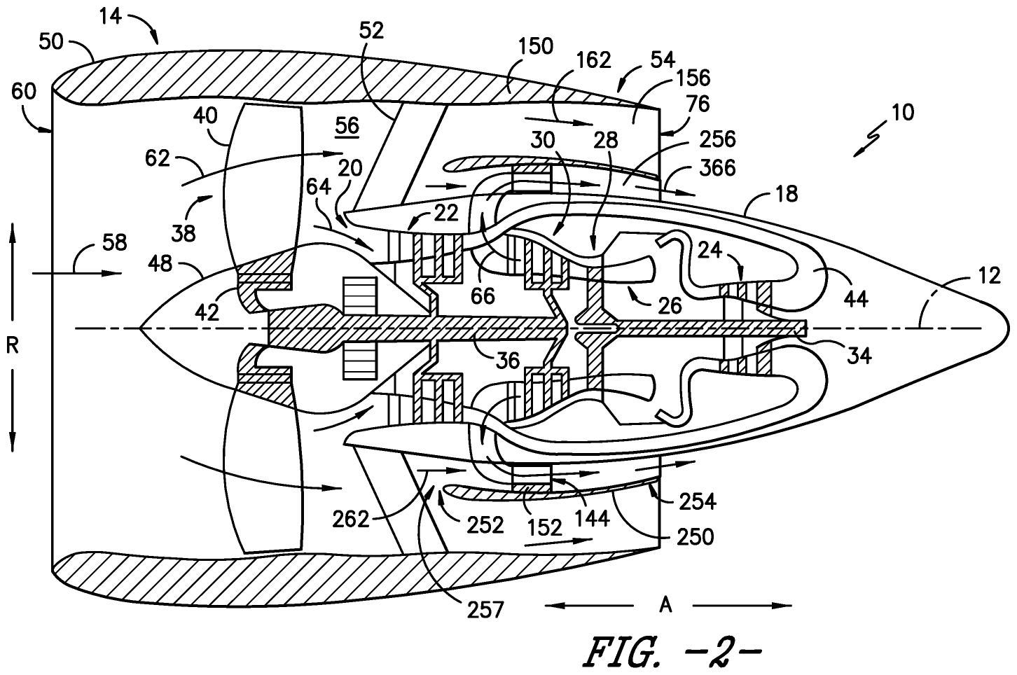

Referring now to the drawings, wherein identical numerals indicate the same elements throughout the figures, FIG. 1 is a schematic cross-sectional view of a generally straight-flow turbofan engine in accordance with an exemplary embodiment of the present disclosure. FIG. 2 is a schematic cross-sectional view of a reverse flow turbofan engine in accordance with another exemplary embodiment of the present disclosure. As shown in FIGS. 1-2, embodiments of the gas turbine engine 10 (hereinafter, “engine 10”) defines an axial direction A (extending parallel to a longitudinal centerline 12 provided for reference) and a radial direction R. In general, the engine 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including one or more of a booster or low pressure (LP) compressor 22 and a high pressure (HP) compressor 24; a combustion section 26; a turbine section including one or more of a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. In other embodiments of engine 10, additional spools may be provided such that engine 10 may be described as a multi-spool engine (e.g., an intermediate pressure spool drivingly connected to an intermediate pressure turbine and an intermediate pressure compressor).

For the depicted embodiment, fan section 14 includes a fan 38 having a plurality of fan blades 40 coupled to a disk 42 in a spaced apart manner. As depicted, fan blades 40 extend outward from disk 42 generally along the radial direction R. The fan blades 40 and disk 42 are together rotatable about the longitudinal axis 12 by LP shaft 36. In some embodiments, a power gear box having a plurality of gears may be included for proportional adjustment of the rotational speed of the LP shaft 36 to a more efficient rotational fan speed. In still certain embodiments, the fan blades 40 are operably coupled to a variable pitch device configured to adjust the pitch of one or more fan blades 40.

Referring still to the exemplary embodiments of FIGS. 1-2, disk 42 is covered by front nacelle or spinner 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that nacelle 50 may be configured to be supported relative to the core turbine engine 16 by a plurality of circumferentially-spaced outlet guide vanes or first struts 52. However, in other embodiments, the outlet guide vanes or first struts 52 are positioned at a bypass airflow passage 56 to desirably condition flow (e.g., acoustics, thrust vector, etc.) from the fan assembly 14.

The bypass airflow passage 56 generally includes an area aft or downstream of the fan blades 40 across which air from the fan blades 40 does not enter the core turbine engine 16. In certain embodiments, a downstream section or aft end 54 of the nacelle 50 may extend over an outer portion of the core turbine engine 16 so as to enclose the bypass airflow passage 56 between the nacelle 50 and the outer casing 18 of the core turbine engine 16. In certain embodiments, the engine 10 may include a high bypass ratio unducted fan engine (e.g., propfan or unducted rotor engine) in which the fan blades 40 are not radially surrounded by a fan shroud 150.

During operation of the engine 10, a volume of air 58 enters engine 10 through an associated inlet 60 of the nacelle 50 and/or fan section 14. As the volume of air 58 passes across fan blades 40, a first portion of the air 58 as indicated by arrows 62 is directed or routed into the bypass airflow passage 56 and a second portion of the air 58 as indicated by arrows 64 is directed or routed into a core flowpath 44 and through the LP compressor 22. The ratio between the first portion of air 62 and the second portion of air 64 is commonly known as a bypass ratio or fan bypass ratio. The pressure of the second portion of air 64 is then increased as it is routed through the core flowpath 44 across the high pressure (HP) compressor 24 and into the combustion section 26, where it is mixed with fuel and burned to provide combustion gases 66.

The combustion gases 66 are routed through core flowpath 44 through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the core flowpath 44 through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

Referring to FIG. 1, the combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the engine 10, also providing propulsive thrust. The HP turbine 28, the LP turbine 30, and the jet exhaust nozzle section 32 at least partially form a hot gas path 78 for routing the combustion gases 66 through the core turbine engine 16.

Referring to FIG. 2, in certain embodiments, the core turbine engine 16 is configured as a reverse flowpath. In such an embodiment, the second portion of air 64 is routed through the annular inlet 20 and through the LP compressor 22. The core flowpath 44 extends along a first direction along the axial direction A, such as co-directional to the first portion of air 62 across the fan section 14. The core flowpath 44 then curves or otherwise extends along a second direction along the axial direction A opposite of the first direction (e.g., the flow of compressed air 64 is reversed relative to the flow of air 62 across the fan section 14). The flow of air 64 is further compressed at a second compressor, such as the HP compressor 24 defining an axial compressor and/or a centrifugal compressor. The air 64 is further provided to the combustion section 66 and one or more turbines 28, 30 such as described above.

Referring back to FIGS. 1-2, it will be appreciated that, although described with respect to engine 10 having a two-spool core turbine engine 16, the present subject matter may be applicable to gas turbine engine configurations with a three-spool core turbine engine 16 (e.g., a low pressure spool, an intermediate pressure spool, and a high pressure spool). Additionally, or alternatively, as further described herein, the present subject matter may particularly apply to high bypass ratio turbofan or propfan engines, such as defining the fan bypass ratio equal to or greater than 10 (i.e., a ratio of flow to the bypass airflow passage 56 versus core turbine engine 16 via the annular inlet 20). It should further be appreciated that various embodiments of the engine 10 further include systems and sub-systems, such as, but not limited to, electric machines, gearboxes, accessory gear assemblies, bleed systems, actuators, controllers, etc. and are omitted for clarity.

In various embodiments, the fan assembly 14 forms a forward-most or first stage blade assembly that is rotatable relative to the longitudinal centerline axis 12. The engine 10 includes the first stage blade assembly, the compressor section including one or more compressors 22, 24, and the turbine section including one or more turbines 28, 30 together positioned in sequential serial flow arrangement relative to the core flowpath 44. The core turbine engine 16 includes the core flowpath 44 forming a core flowpath outlet 144.

In certain embodiments, the annular fan casing or outer nacelle 50 forms a fan shroud 150 surrounding the first stage blade assembly. The annular fan casing or outer nacelle 50 defining the fan shroud 150 is extended the longitudinal direction L around at least a portion of the core turbine engine 16 surrounded by the outer casing 18. A bypass duct splitter or shroud 250 is extended along the longitudinal direction L around at least a portion of the core turbine engine 16, in which the core turbine engine 16 is surrounded by the outer casing 18. The shroud 250 is positioned in the bypass airflow passage 56 aft or downstream of the fan assembly 14. The shroud 250 is positioned outward along the radial direction R from the outer casing 18 surrounding the core turbine engine 16. The shroud 250 is further positioned inward along the radial direction R of a radially outermost tip of the fan blades 40 (i.e., the shroud 250 is positioned within a diameter less than the diameter of the plurality of fan blades 40). In certain embodiments, the shroud 250 is positioned radially between the outer casing 18 and the fan shroud 150.

The bypass airflow passage 56 is split (e.g., bisected) by the shroud 250 into a first flowpath 156 radially outward of the shroud 250 and a second flowpath 256 radially inward of the shroud 250. In certain embodiments, the first flowpath 156 is extended between the fan shroud 150 and the shroud 250. The bypass airflow passage 56 is split by the shroud 250 into the first flowpath 156 and the second flowpath 256 extended between the shroud 250 and the outer casing 18 of the core turbine engine 16. During operation of the engine 10, the bypass air or first portion of air 62 is split between a first bypass flow portion 162 through the first flowpath 156 and a second bypass flow portion 262 through the second flowpath 256. The core flowpath outlet 144 and the second flowpath 256 are in fluid communication radially inward of the shroud 250. In certain embodiments, the core flowpath outlet 144 and the second flowpath 256 are in fluid communication between the shroud 250 and the outer casing 18 of the core turbine engine 16.

In various embodiments, the shroud 250 and the outer casing 18 or core turbine engine 16 are in concentric arrangement relative to the longitudinal centerline axis 12. In certain embodiments, the fan shroud 150 is positioned in substantially concentric arrangement to the outer casing 18 by at least the first strut 52. The shroud 250 is positioned in substantially concentric arrangement to the outer casing 18 by a second strut 152. The second strut 152 is extended from the outer casing 18 to the shroud 250. In various embodiments, the second strut 152 includes a radial span less than the fan blades 40, such as to position the shroud 250 at or less than a radial span of the fan blades 40. In certain embodiments, the second strut 152 is a portion of the jet exhaust nozzle section 32. In still certain embodiments, the second strut 152 is extended from the core engine 16 aft of one or more of the turbines 28, 30. In some embodiments, the second strut 152 is a portion of an inter-turbine or mid-turbine frame static support assembly.

In various embodiments, a forward end 252 of the shroud 250 is positioned within bypass airflow passage 56. In certain embodiments, the second flowpath 256 forms a second flowpath inlet 257 at the forward end 252 of the shroud 250. The second flowpath inlet 257 is formed between the shroud 250 and the outer casing 18 of the core turbine engine 16. The second flowpath inlet 257 is in fluid communication with the bypass airflow passage 56. In various embodiments, the second flowpath inlet 257 is in the bypass airflow passage 56 between the fan shroud 150 and the outer casing 18 of the core turbine engine 16.

In certain embodiments, such as depicted in regard to FIG. 1, an aft end 254 of the shroud 250 is positioned aft along the axial direction A of a fan shroud aft end 54. In some embodiments, the shroud aft end 254 is extended axially aft or co-planar of the core flowpath outlet 144. In other embodiments, such as depicted in FIG. 2, the shroud aft end 254 is positioned co-planar or forward along the axial direction A of the fan shroud aft end 54.

Referring to FIG. 1, the outer casing 18 may form, at least in part, an exhaust mixer 146 aft or downstream of the turbines 28, 30. In certain embodiments, the exhaust mixer 146 is positioned at the outer casing 18 at the exhaust nozzle section 32. The combustion gases 66 exhaust from the core turbine engine 16 from the core flowpath 44, such as through the core flowpath outlet 144. In various embodiments, an aft end of the core engine 16 includes the exhaust mixer 146 at which the combustion gases 66 from the core flowpath 44 mix with the second bypass flow portion 262 between the radially inward of the shroud 250.

In still various embodiments, the core flowpath outlet 144 is positioned forward or upstream of the downstream end or aft end 254 of the shroud 250. In various embodiments, the exhaust mixer 146 includes a lobed or contoured structure to promote mixing of the combustion exhaust gases 66 and the second bypass flow portion 262 of fan bypass flow 66.

Referring to FIGS. 1-2, during operation of the engine 10, the second bypass flow portion 262 flows through the second flowpath 256 from the upstream end or forward end 252 and through the downstream end or aft end 254. In the second flowpath 256, the second bypass flow portion 262 of fan bypass air 62 is channeled or flowed between the outer casing 18 and the shroud 250. The second bypass flow portion 262 of fan bypass air 62 is mixed with the combustion gases 66 exiting from the core flowpath 44. The combustion gases 66 exit the core flowpath 44 through the core flowpath outlet 144 positioned forward or upstream of the aft end 254 of the shroud 250. A volume of the second flowpath 256 between the shroud 250 and the outer casing 18 corresponds to a mass flow ratio of fan bypass gases at the second flowpath 256 to combustion exhaust gases 66 from the core flowpath 44. In certain embodiments, such as depicted in FIG. 1, the core flowpath outlet 144 is positioned aft of the turbine section including one or more turbines 28, 30. In other embodiments, such as depicted in FIG. 2, the core flowpath outlet 144 is positioned radially outward of the compressor section including one or more compressors 22, 24. In still various embodiments, the core flowpath outlet 144 is positioned radially outward of the outer casing 18 of the core turbine engine 16.

It should be appreciated that the volume of the second flowpath 256 is extended from the forward end 252 of the shroud 250. In various embodiments, the volume is further extended to the aft end 254 of the shroud 250. In certain embodiments, the volume is extended to the aft end 254 of the shroud 250 aft of the core flowpath outlet 144. In various embodiments, the volume is extended to the aft end 254. In certain embodiments, the volume is extended to the core flowpath outlet 144 forward of the aft end 254. In various embodiments, the core flowpath outlet 144 is positioned forward or upstream of the aft end 254 of the shroud 250 such as to provide a volume at which combustion gases 66 and the second portion of bypass flow 262 is mixed, such as to reduce noise and improve engine efficiency and/or performance such as described herein.

During operation, such as at a maximum power (e.g., takeoff) condition, the mass flow ratio is between 0.5 and 5.0 for certain embodiments of the engine 10. For example, the mass flow ratio is a ratio of the second bypass flow portion 262 of fan bypass air 62 at the second flowpath 256 to combustion gases 66 entering the second flowpath 256 from the core flowpath 44. In one embodiment, the volume of the second flowpath 256 corresponds to a radial spacing of the shroud 250 from the outer casing 18 versus the bypass airflow passage 56. In certain embodiments, the volume of the second flowpath 256 corresponds to a radial spacing of the shroud 250 from the outer casing 18 versus a radial spacing of the fan shroud 150 from outer casing 18.

As such, the mass flow ratio, and ranges thereof, corresponds to the structure of the shroud 250 relative to the outer casing 18 of the core turbine engine 16. In certain embodiments, the mass flow ratio corresponds to the structure of the shroud 250 relative to a diameter of the plurality of fan blades 40. In still certain embodiments, the mass flow ratio corresponds to the structure of the shroud 250 relative to the bypass airflow passage 56. In still various embodiments, the mass flow ratio corresponds to the structure of the fan shroud 150 relative to the shroud 250. In such various embodiments, the mass flow ratio further corresponds to the volume of combustion gases exiting the core flowpath 44 to the second flowpath 256. In still certain embodiments, the mass flow ratio corresponds to the structure of the fan shroud 150 relative to the shroud 250 and the flowpath outlet 144. In various embodiments, the mass flow ratio corresponds to the structures providing a first mass flow of the second bypass flow portion of air 262 five times greater than a second mass flow of combustion gases (e.g., combustion gases 66). In other embodiments, the mass flow ratio corresponds to the structures provided the first mass flow of the second bypass flow portion 262 of air 0.5 times the second mass flow of combustion gases. In still various embodiments, the range of ratios of mass flow is less than or equal to 3.0. In yet another embodiment, the range of ratios of mass flow is less than 2.5. In still another embodiment, the range of ratios of mass flow is less than 2.3. In still other embodiments, the range of ratios of mass flow is greater than 1.0. In still yet other embodiments, the range of ratios of mass flow is greater than 1.3.

In still additional or alternative embodiments of the engine 10 provided herein, a volume between the shroud 250 and the outer casing 18 of the core engine 16 corresponds to a pressure ratio of fan bypass gases (e.g., the second portion of bypass air 262) at the second flowpath 256 to combustion exhaust gases from the core flowpath 44 between 0.8 and 1.4 during operation of the engine 10. In some embodiments, the pressure ratio is less than 1.2. In other embodiments, the pressure ratio is greater than 1.0.

It should be appreciated that ranges of pressure ratios and/or ratios of mass flow of second bypass flow portion of air 262 to combustion gases provides particular benefits not previously known in the art. In certain instances, ranges less than those provided herein may undesirably remove benefits associated with fan bypass air and combustion gas mixing. In other instances, ranges greater than those provided herein may result in the fan shroud 150 and/or the shroud 250 of undesirably high or heavy weight. Loss of benefits may include undesired reduction in propulsive efficiency, fuel burn, or specific fuel consumption (SFC). Additionally, or alternatively, the ranges provided herein may provide for improved propulsive efficiency, fuel burn, or SFC, for turbofan engines with fan bypass ratios greater than or equal to 6. In certain embodiments, the ranges provided herein may provide for improved propulsive efficiency for turbofan engines with fan bypass ratios greater than or equal to 10.

It should be appreciated that in certain embodiments, the fan shroud 150 includes a first adjustable area nozzle. In still certain embodiments, the shroud 250 includes a second adjustable area nozzle. As such, in various embodiments, the engine 10 may include actuators, doors, hydraulic or pneumatic systems, or other components providing actuation, movement, or adjustment of a first area between the fan shroud 150 and the shroud 250 and/or a second area between the shroud 250 and the outer casing 18 of the core turbine engine 16 shroud 250 and the outer casing 18 of the core turbine engine 16. Various embodiments of the fan shroud 150 and/or the shroud 250 including an adjustable area nozzle include adjusting the respective areas within one or more of the pressure ratios and/or mass flow ratios provided herein.

Embodiments of the engine 10 provided herein generally provide a partial high bypass flow mixing of fan bypass air 62 with exhaust gases from the core turbine engine 16. A first portion of fan bypass air 162 exits unmixed from the fan bypass passage 56. A second portion of fan bypass air 262 mixes with at least a portion of the combustion gases 66 radially inward of the second flowpath 256 as a single stream of mixed gases 366 exhausted from the second flowpath 256. Embodiments of the engine 10 provided herein include combinations of the shroud 250 and the core flowpath outlet 144 providing unexpected benefits for high bypass gas turbine engines (e.g., high bypass turbofan engines), such as improved fan bypass and exhaust gas mixing, improved specific fuel consumption, improved fuel burn, improved propulsive efficiency, and/or improved noise abatement. Structures, ratios, or ranges of ratios provided herein may further allow for one or more aforementioned improvements in high bypass turbofan engines over those for low bypass turbofan engines, such as, but not limited to, overcoming losses associated with increased weight, increased SFC or fuel burn, increased noise, or decreased propulsive efficiency.

Additionally, or alternatively, it should be appreciated that low bypass turbofan engines generally provide higher fuel consumption in contrast to high bypass turbofan engines. As such, embodiments of the engine 10 provided herein, including particular ranges or ratios provided herein, may allow for, and further improve upon, acoustic, thrust output, and specific fuel consumption benefits typically associated with high bypass turbofan engines, while mitigating or eliminating deleterious effects associated with the weight of an exhaust mixer or shroud.

It should be appreciated that in various embodiments of the engine 10 provided herein, one or more beneficial ranges of pressure ratio and/or mass flow ratio not previously known in the art corresponding to the fan shroud 150, the shroud 250, a volume between the shroud 250 and the outer casing 18, a volume between the fan shroud 150 and the outer casing, a volume between the fan shroud 150 and the shroud 250, an axial dimension from the shroud inlet 257 and the shroud aft end 254, the core flowpath outlet 144, or combinations thereof. One or more structures provided herein may allow for unexpected benefits during operation of the engine 10. In certain exemplary embodiments, operation of the engine 10 corresponding to one or more of the pressure ratio and/or mass flow ratio disclosed herein may further correspond to a maximum operating condition of the engine (e.g., takeoff condition). In other exemplary embodiments, operation of the engine 10 corresponding to one or more of the pressure ratio and/or mass flow ratio disclosed herein may further correspond to a mid-power operating condition of the engine (e.g., cruise condition), or greater (e.g., climb condition), such as understood in a landing-takeoff (LTO) cycle of an aircraft.

In some embodiments, components of the engine 10, such as the fan shroud 150, the shroud 250, and/or the outer casing 18, may be formed of a composite material, such as a polymer matrix composite (PMC) material or a ceramic matrix composite (CMC) material, which has high temperature capability, or combinations thereof with a metal or metal alloy. Composite materials generally include a fibrous reinforcement material embedded in matrix material, e.g., a polymer or ceramic matrix material. The reinforcement material serves as a load-bearing constituent of the composite material, while the matrix of a composite material serves to bind the fibers together and act as the medium by which an externally applied stress is transmitted and distributed to the fibers.

PMC materials are typically fabricated by impregnating a fabric or unidirectional tape with a resin (prepreg), followed by curing. Prior to impregnation, the fabric may be referred to as a “dry” fabric and typically includes a stack of two or more fiber layers (plies). The fiber layers may be formed of a variety of materials, nonlimiting examples of which include carbon (e.g., graphite), glass (e.g., fiberglass), polymer (e.g., Kevlar®) fibers, and metal fibers. Fibrous reinforcement materials can be used in the form of relatively short chopped fibers, generally less than two inches in length, and more preferably less than one inch, or long continuous fibers, the latter of which are often used to produce a woven fabric or unidirectional tape. PMC materials can be produced by dispersing dry fibers into a mold, and then flowing matrix material around the reinforcement fibers, or by using prepreg. For example, multiple layers of prepreg may be stacked to the proper thickness and orientation for the part, and then the resin may be cured and solidified to render a fiber reinforced composite part. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermosplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), and polyimide resins.

Exemplary CMC materials may include silicon carbide (SiC), silicon, silica, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., 3M's Nextel 440 and 480), and chopped whiskers and fibers (e.g., 3M's Nextel 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together (e.g., as plies) to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition. In other embodiments, the CMC material may be formed as, e.g., a carbon fiber cloth rather than as a tape.

In various embodiments shown and described herein, the fan shroud 150, the shroud 250, and/or the outer casing 18 includes at least one composite wall. The composite material of the composite wall of the shrouds 150, 250 and/or outer casing 18 preferably is a lightweight and high-strength material, such a PMC or CMC material. As described in greater detail below, an exemplary composite wall of the fan shroud 150, the shroud 250, and/or outer casing 18 has a ply layup that is varied circumferentially such that the orientation of at least one ply of the ply layup in one region is different from the orientation of the plies in an adjoining region. The circumferentially varied ply layup is designed to guide strains induced during large applied loads, such as, during blade-out events (e.g., detachment of one or more rotating airfoils during operation, such as the fan blade 40 circumferentially surrounded by the fan shroud 150, or one or more rotating airfoils at one or more turbines 28, 30 radially surrounded by the shroud 250), and to arrest cracks resulting from blade penetration, vibrations, etc. It is highly beneficial during a blade-out event to arrest and guide crack propagation to preserve at least one load path of the fan shroud 150 and/or the shroud 250. Additionally, or alternatively, the composite structure of the fan shroud 150, the shroud 250, and/or the outer casing 18 may permit one or more beneficial ranges of mass flow ratio, pressure ratio and/or bypass ratio. Furthermore, or alternatively, the one or more benefits described herein may be achieved while further providing a containment structure around the turbines 28, 30, thereby allowing for weight gains at the shroud 250 to be offset by weight reduction at the outer casing 18 or one or more other shrouds, cases, frames, or other structures surrounding rotatable components of the turbines 28, 30. As such, one or more benefits described herein may be achieved while mitigating or eliminating deleterious effects related to weight or other performance losses at the engine 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

1. A gas turbine engine, the engine comprising a core turbine engine forming a core flowpath, a rotatable first stage blade assembly, wherein a bypass airflow passage is formed downstream of the first stage blade assembly, and a shroud positioned at the bypass airflow passage radially outward of the core turbine engine. A first flowpath is formed outward of the shroud at which a first portion of air is flowed, and the shroud and the core turbine engine form a second flowpath therebetween. The core flowpath is in fluid communication with the second flowpath to flow a mixture of a second portion of air and combustion gases in the second flowpath.

2. The engine of any clause herein, wherein the rotatable first stage blade assembly and the core turbine engine together form a bypass ratio greater than or equal to 6.

3. The engine of any clause herein, wherein a volume at the second flowpath corresponds to a mass flow ratio of the second portion of air to combustion gases, and wherein the mass flow ratio is between 0.5 and 5.0.

4. The engine of any clause herein, wherein the mass flow ratio is less than 3.0.

5. The engine of any clause herein, wherein the mass flow ratio is greater than 0.8.

6. The engine of any clause herein, wherein a volume at the second flowpath corresponds to a pressure ratio of the second portion of air at the second flowpath to combustion gases from the core flowpath, and wherein the pressure ratio is between 0.8 and 1.4.

7. The engine of any clause herein, wherein the pressure ratio is less than 1.2.

8. The engine of any clause herein, wherein the pressure ratio is greater than 1.0.

9. The engine of any clause herein, wherein the shroud and the core turbine together form a second flowpath inlet positioned in fluid communication in the bypass airflow passage.

10. The engine of any clause herein, the engine comprising a fan shroud radially surrounding the first stage blade assembly, wherein the bypass airflow passage is formed between the casing and the core turbine engine.

11. The engine of any clause herein, wherein a shroud aft end is positioned aft along an axial direction of a fan shroud aft end.

12. The engine of any clause herein, wherein a shroud aft end is positioned aft along the axial direction of a core flowpath outlet.

13. The engine of any clause herein, wherein the core turbine engine comprises a core flowpath outlet positioned forward of a shroud aft end, wherein the core flowpath outlet is configured to egress combustion gases to the second flowpath.

14. The engine of claim 1, the engine comprising a first strut positioned at the bypass airflow passage aft of the first stage blade assembly, and a second strut connecting the shroud radially outward of the core turbine engine.

15. A high bypass turbofan gas turbine engine, the high bypass gas turbine engine comprising an outer casing surrounding a core turbine engine, wherein the core turbine engine forms a core flowpath, a fan assembly rotatable relative to a longitudinal centerline axis, the fan assembly forming a bypass airflow passage aft of the fan assembly radially outward of the outer casing, and a splitter positioned in the bypass airflow passage. A first flowpath is formed at the bypass airflow passage radially outward of the splitter. The first flowpath receives a first portion of bypass air from the fan assembly. A second flowpath is formed between the splitter and the outer casing. The second flowpath receives a second portion of bypass air from the fan assembly. The core flowpath is in fluid communication with the second flowpath to flow a mixture of the second portion of bypass air and combustion gases in the second flowpath.

16. The engine of any clause herein, wherein the core flowpath comprises a reverse flowpath.

17. The engine of any clause herein, wherein a core flowpath outlet is positioned in the second flowpath radially outward of a compressor section of the core turbine engine.

18. The engine of any clause herein, wherein a volume at the second flowpath from a second flowpath inlet corresponds to a pressure ratio of the second portion of air at the second flowpath to combustion gases from the core flowpath, and wherein the pressure ratio is between 0.8 and 1.4 during operation of the high bypass turbofan engine.

19. The engine of any clause herein, wherein a volume at the second flowpath corresponds to a mass flow ratio of the first portion of air through the first flowpath to the second portion of air through the second flowpath, and wherein the mass flow ratio is between 0.5 and 5.0 during operation of the high bypass turbofan engine.

20. The any clause herein engine of any clause herein, wherein a second flowpath inlet is positioned in fluid communication in the bypass airflow passage, and wherein a core flowpath outlet is positioned forward of a shroud aft end, and wherein the second flowpath comprises a volume corresponding to a pressure ratio between 0.8 and 1.4, a mass flow ratio between 0.5 and 5.0, or both, during operation of the high bypass turbofan engine.

21. The engine of any preceding clause, wherein the mass flow ratio is greater than 0.8.

22. The engine of any preceding clause, comprising a fan bypass ratio greater than or equal to 10.

23. The engine of any preceding clause, the shroud comprising a composite material.

24. The engine of any preceding clause, the fan shroud comprising a composite material.

25. The engine of any preceding clause, the outer casing comprising a composite material.

What is claimed is:

1. A gas turbine engine, the engine comprising:
a core turbine engine forming a core flowpath;
a rotatable first stage blade assembly, wherein a bypass airflow passage is formed downstream of the first stage blade assembly; and
a shroud positioned at the bypass airflow passage radially outward of the core turbine engine, wherein a first flowpath is formed outward of the shroud at which a first portion of air is flowed, and wherein the shroud and the core turbine engine form a second flowpath therebetween, the core flowpath in fluid communication with the second flowpath to flow a mixture of a second portion of air and combustion gases in the second flowpath.

2. The engine of claim 1, wherein the rotatable first stage blade assembly and the core turbine engine together form a bypass ratio greater than or equal to 6.

3. The engine of claim 1, wherein a volume at the second flowpath corresponds to a mass flow ratio of the second portion of air to combustion gases, and wherein the mass flow ratio is between 0.5 and 5.0.

4. The engine of claim 3, wherein the mass flow ratio is less than 3.0.

5. The engine of claim 3, wherein the mass flow ratio is greater than 0.8.

6. The engine of claim 1, wherein a volume at the second flowpath corresponds to a pressure ratio of the second portion of air at the second flowpath to combustion gases from the core flowpath, and wherein the pressure ratio is between 0.8 and 1.4.

7. The engine of claim 6, wherein the pressure ratio is less than 1.2.

8. The engine of claim 6, wherein the pressure ratio is greater than 1.0.

9. The engine of claim 1, wherein the shroud and the core turbine together form a second flowpath inlet positioned in fluid communication in the bypass airflow passage.

10. The engine of claim 1, the engine comprising:
a fan shroud radially surrounding the first stage blade assembly, wherein the bypass airflow passage is formed between the casing and the core turbine engine.

11. The engine of claim 10, wherein a shroud aft end is positioned aft along an axial direction of a fan shroud aft end.

12. The engine of claim 1, wherein a shroud aft end is positioned aft along the axial direction of a core flowpath outlet.

13. The engine of claim 1, wherein the core turbine engine comprises a core flowpath outlet positioned forward of a shroud aft end, wherein the core flowpath outlet is configured to egress combustion gases to the second flowpath.

14. The engine of claim 1, further comprising:
a first strut positioned at the bypass airflow passage aft of the first stage blade assembly; and
a second strut connecting the shroud radially outward of the core turbine engine.

15. A high bypass gas turbine engine, the high bypass gas turbine engine comprising:
an outer casing surrounding a core turbine engine, wherein the core turbine engine forms a core flowpath;
a fan assembly rotatable relative to a longitudinal centerline axis, the fan assembly forming a bypass airflow passage aft of the fan assembly radially outward of the outer casing; and
a splitter positioned in the bypass airflow passage, wherein a first flowpath is formed at the bypass airflow passage radially outward of the splitter, wherein the first flowpath receives a first portion of bypass air from the fan assembly, and wherein a second flowpath is formed between the splitter and the outer casing, the second flowpath receiving a second portion of bypass air from the fan assembly, and wherein the core flowpath is in fluid communication with the second flowpath to flow a mixture of the second portion of bypass air and combustion gases in the second flowpath.

16. The high bypass gas turbine engine of claim 15, wherein the core flowpath comprises a reverse flowpath.

17. The high bypass gas turbine engine of claim 16, wherein a core flowpath outlet is positioned in the second flowpath radially outward of a compressor section of the core turbine engine.

18. The high bypass gas turbine engine of claim 15, wherein a volume at the second flowpath from a second flowpath inlet corresponds to a pressure ratio of the second portion of air at the second flowpath to combustion gases from the core flowpath, and wherein the pressure ratio is between 0.8 and 1.4 during operation of the high bypass turbofan engine.

19. The high bypass gas turbine engine of claim 15, wherein a volume at the second flowpath corresponds to a mass flow ratio of the first portion of air through the first flowpath to the second portion of air through the second flowpath, and wherein the mass flow ratio is between 0.5 and 5.0 during operation of the high bypass turbofan engine.

20. The high bypass gas turbine engine of claim 15, wherein a second flowpath inlet is positioned in fluid communication in the bypass airflow passage, and wherein a core flowpath outlet is positioned forward of a shroud aft end, and wherein the second flowpath comprises a volume corresponding to a pressure ratio between 0. 8 and 1.4, a mass flow ratio between 0.5 and 5.0, or both, during operation of the high bypass turbofan engine.
